(19) United States
(12) Patent Application Publication
(10) Pub. No.: US 2026/0194087 A1
(43) Pub. Date: Jul. 9, 2026

(54) Spring Clip

(71) Applicant: Illinois Tool Works Inc., Glenview, IL (US)

(72) Inventors: Mark A. Beyer, Armada, MI (US); Jeremy Reed, Gallatin, TN (US)

(21) Appl. No.: 19/421,119

(22) Filed: Dec. 16, 2025

Related U.S. Application Data
(60) Provisional application No. 63/742,490, filed on Jan. 7, 2025.

(51) Int. Cl. F16B 2/24; F16B 5/02

(52) U.S. Cl. CPC F16B 2/24; F16B 5/0233

(57) ABSTRACT

Disclosed is a spring clip for a compensating assembly. The spring clip includes a cylindrical sidewall that defines a slot and a plurality of windows. Each of the plurality of windows includes a cantilevered spring tab. The cylindrical sidewall is coaxial with a central longitudinal axis. The slot is defined by spaced-apart first and second edges. The edges have non-linear profiles to reduce entanglement. Each of the plurality of cantilevered spring tabs including a root section, a body section, and a free end. The slot can obstruct a direct line-of-sight through the slot to mitigate interference with other components. The slot can include a stepped, a trapezoidal profile, a triangular profile, a quadrilateral profile, a curved profile, or a sawtooth profile. Each spring tab includes multiple bends to provide flexibility, reduce insertion forces, and mitigate interference with other components. The free end of each spring tab is outwardly angled to facilitate assembly and prevent sharp-edge interference.

### CROSS-REFERENCE

The present application claims priority to U.S. Provisional Patent Application No. 63/742,490, filed Jan. 7, 2025, and entitled “Spring Clip” which is hereby incorporated by reference in its entirety.

### BACKGROUND

Automotive components require fastening techniques that are simple to manufacture and assemble. Moreover, fastening techniques should be reliable and efficient. Spring clips are sometimes used to compensate for tolerances between components, as well as to help manage those tolerances within the device itself. For example, tolerance-compensation devices can include a base element mounted to one component and a compensation element threadedly engaged with the base element.

As the spring clip is inserted into the tolerance-compensation device, portions of the clip may contact the compensation element early in the process. This resistance increases the force required during installation. Additionally, if the spring clip becomes partially dislodged from the passage, its barbs may lose their anchoring capability and fail to re-engage securely with the passage walls.

Therefore, despite advancements to date, there remains a need for a spring clip that simplifies installation while ensuring secure retention after placement.

### SUMMARY

The present disclosure relates generally to a spring clip, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates an isometric assembly view of a fastener-retaining system having a fastener assembly with a spring clip in accordance with an aspect of this disclosure.

FIG. 1b illustrates an assembled isometric view of the fastener-retaining system.

FIGS. 1c and 1d illustrate, respectively, side and isometric assembly views of the fastener assembly taken along cutline A-A (FIG. 1a).

FIGS. 1e and 1f illustrate, respectively, side and isometric assembled views of the fastener assembly taken along cutline B-B (FIG. 1b).

FIGS. 2a and 2b illustrate, respectively, first and second isometric views of the spring clip in accordance with an aspect of this disclosure.

FIGS. 2c and 2d illustrate, respectively, top and bottom plan views of the spring clip.

FIGS. 2e through 2h illustrate, respectively, first, second, third, and fourth side elevation views of the spring clip.

FIGS. 2i and 2j illustrate, respectively, side and isometric views of the spring clip taken along cutline C-C (FIG. 2d).

FIGS. 2k and 2l illustrate, respectively, side and isometric views of the spring clip taken along cutline D-D (FIG. 2d).

FIGS. 3a through 3f illustrate alternative slot designs for use with a spring clip in accordance with another aspect of this disclosure.

FIGS. 4a through 4d illustrate, respectively, first, second, third, and fourth side elevation views of a spring clip in yet accordance with another aspect of this disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a spring clip that can be produced through a metal stamping process. For example, a generally rectangular, flat metal plate serves as the starting material. During the stamping process, various features of the spring clip, including the outer shape, windows, and spring tabs, are defined, and stamped. Once stamped, the flat plate is bent along its central longitudinal axis to form a cylindrical sidewall. The long axis of the metal plate (i.e., the wide length) is perpendicular to the central longitudinal axis during the bending process. This process results in a cylindrical structure with a plurality of slots, each slot having a spring tab. Further, the short edges of the metal plate (now shaped like a cylindrical sidewall) remain spaced apart to form a slot.

In one example, a spring clip comprises: a cylindrical sidewall defining a central longitudinal axis; a slot in the cylindrical sidewall defined by spaced-apart first and second edges; and a plurality of cantilevered spring tabs formed in the cylindrical sidewall, wherein each of the plurality of cantilevered spring tabs extends toward the central longitudinal axis.

In certain aspects, the spaced-apart first and second edges are configured to reduce entanglement by obstructing a direct line-of-sight through the slot.

In certain aspects, each of the spaced-apart first and second edges has a non-linear profile.

In certain aspects, each of the spaced-apart first and second edges has a stepped, trapezoidal profile.

In certain aspects, each of the spaced-apart first and second edges has a triangular profile.

In certain aspects, each of the spaced-apart first and second edges has a stepped, quadrilateral profile.

In certain aspects, each of the spaced-apart first and second edges has a curved profile.

In certain aspects, each of the spaced-apart first and second edges has a sawtooth profile.

In certain aspects, each of the plurality of cantilevered spring tabs is positioned within a window formed in the cylindrical sidewall.

In certain aspects, each of the plurality of cantilevered spring tabs includes a root section, a body section, and a free end.

In certain aspects, the root section is coupled to an edge of the window.

In certain aspects, the body section is parallel to the central longitudinal axis.

In certain aspects, the root section is transverse relative to the central longitudinal axis.

In certain aspects, the free end extends away from the central longitudinal axis.

In certain aspects, the spring clip is a stamped-metal spring clip.

In another example, a spring clip comprises: a cylindrical sidewall defining a central longitudinal axis; a plurality of windows formed in the cylindrical sidewall and distributed evenly about the central longitudinal axis, wherein each of the plurality of windows includes a cantilevered spring tabs extends toward the central longitudinal axis; and a slot in the cylindrical sidewall defined by spaced-apart first and second edges, wherein each of the spaced-apart first and second edges has a non-linear profile.

In certain aspects, the cantilevered spring tab includes a root section that is coupled to the edge of the window, a body section, and a free end that extends away from the central longitudinal axis.

In certain aspects, the body section is parallel to the central longitudinal axis.

In certain aspects, the spring clip is a stamped-metal spring clip.

In yet another example, a fastener assembly for coupling a first component and a second component comprises: a fastener; a threaded sleeve having a threaded body defining a sleeve through-hole; a retainer configured to couple with the first component, wherein the retainer includes an internally-threaded collar configured to threadedly receive the threaded sleeve; a spring clip having a cylindrical sidewall with a passageway defining a central longitudinal axis, a slot in the cylindrical sidewall defined by spaced-apart first and second edges, and a plurality of cantilevered spring tabs formed in the cylindrical sidewall, wherein each of the plurality of cantilevered spring tabs extends toward the central longitudinal axis, and wherein the sleeve through-hole is configured to receive the spring clip.

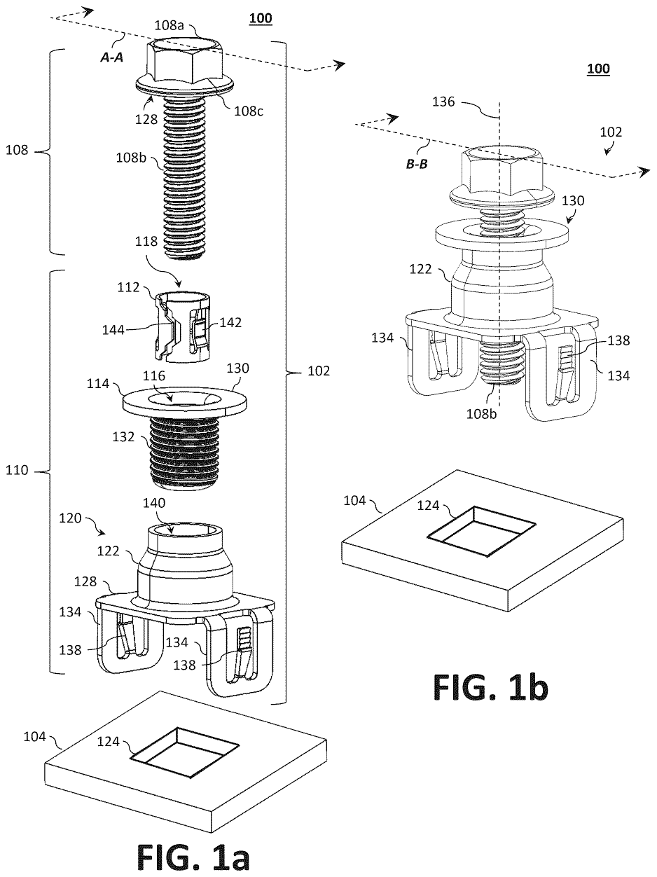

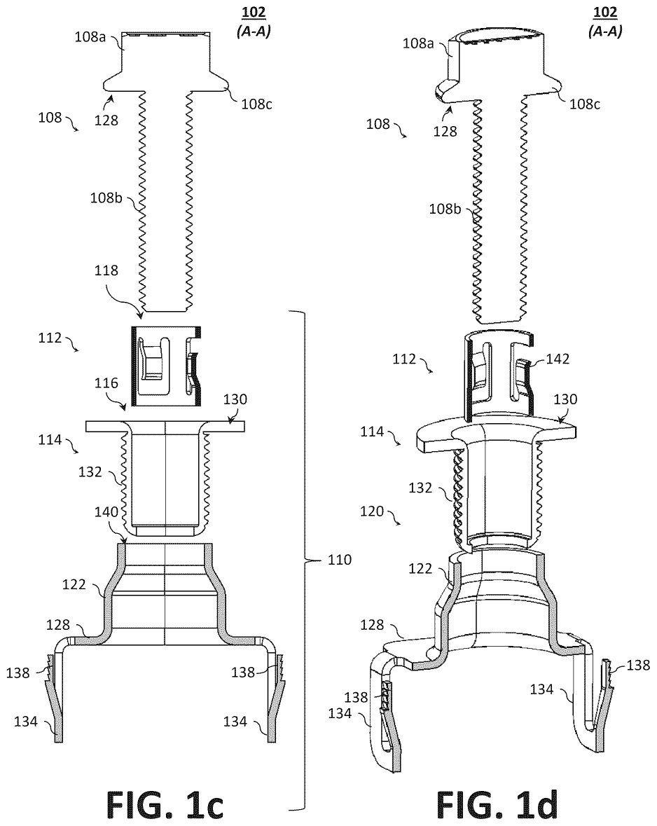

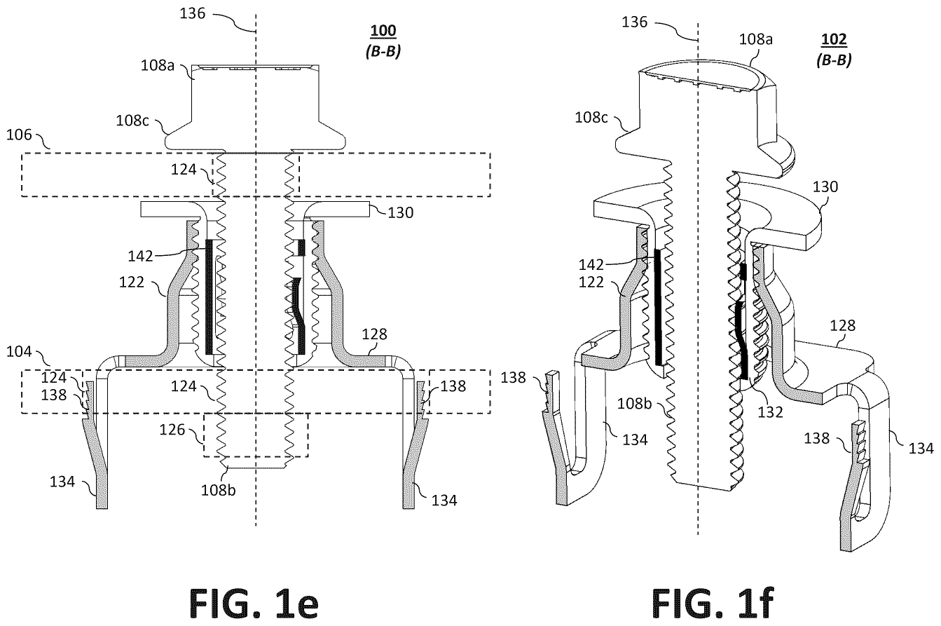

FIGS. 1a through 1f illustrate a fastener-retaining system 100 in accordance with an aspect of this disclosure, having a fastener assembly 102 configured to couple a first component 104 relative to a second component 106 via a fastener 108 and a compensating assembly 110 having a spring clip 112. The second component 106 is omitted from FIGS. 1a through 1d and 1f for illustrative purposes, but a non-limiting example is illustrated in FIG. 1 e. More specifically, FIG. 1a illustrates an isometric assembly view of a fastener-retaining system 100 having a fastener assembly 102 with a spring clip 112 in accordance with an aspect of this disclosure, while FIG. 1b illustrates an assembled isometric view of the fastener-retaining system 100. FIGS. 1c and 1d illustrate, respectively, side and isometric assembly views of the fastener assembly 102 taken along cutline A-A (FIG. 1a), while FIGS. 1e and 1f illustrate, respectively, side and isometric assembled views of the fastener assembly 102 taken along cutline B-B (FIG. 1b).

The illustrated fastener-retaining system 100 includes a first component 104, a second component 106, and a fastener assembly 102. The fastener assembly 102 is configured to join the first component 104 and the second component 106 while compensating for tolerances. In this example, the fastener assembly 102 generally comprises a fastener 108 and a compensating assembly 110. The fastener assembly 102 can be used with, for example, the first component 104 in the form of a panel or sheet of metal having an opening 124 (or cutout) to receive and secure the compensating assembly 110, and a second component 106 having an opening to receive the fastener 108 (e.g., a round hole). The disclosed fastener assembly 102 provides a robust connection between the first component 104 and the second component 106.

The fastener 108 is illustrated as a male fastener (e.g., a head 108a connected to a collar 108c with an externally threaded shank 108b) that is configured to engage a female fastener (e.g., an internally threaded component, such as a threaded collar, threaded opening, a nut 126, etc.). The fastener 108 may be a bolt, for example. At least a portion of the shank 108b is externally threaded. The shank 108b is coaxial with the head 108a and the collar 108c. In the illustrated example, the male fastener 108 is a threaded bolt with a hex-shaped head, but other types of fasteners and fastener heads are contemplated. The shank 108b of the fastener 108 passes through the compensating assembly 110 (e.g., via a passageway 118 of the spring clip 112). While a bolt is illustrated, a stud (or similar component) can be used in lieu of the bolt.

The compensating assembly 110 is illustrated as a multi-component retainer clip assembly comprising a retainer 120, a threaded sleeve 114, and a spring clip 112. The threaded sleeve 114 generally comprises a flange 130 and a threaded body 132. The flange 130 is generally annular, while the threaded body 132 is a tubular shaft with external threads. As illustrated, when assembled, a lower surface of the collar 108c is configured to abut the flange 130 of the threaded body 132 of the threaded sleeve 114, with the second component 106 therebetween.

The illustrated retainer 120 is formed as a base 128 having an internally threaded collar 122 formed thereon (e.g., via cold forming) that includes a threaded passageway 140 therethrough. The threaded passageway 140 is configured to threadedly engage the threaded sleeve 114. The base 128 comprises a pair of legs 134 resiliently coupled thereto that are generally perpendicular to the base 128. Each of the legs 134 comprises one or more attachment features, such as the illustrated tabs 138. The retainer 120 can be fabricated as a stamped-metal component, for example.

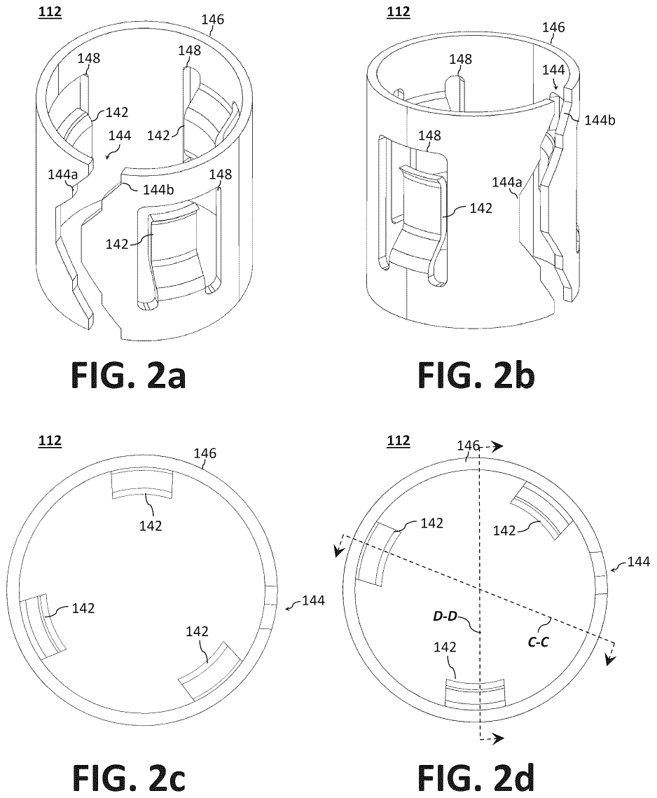

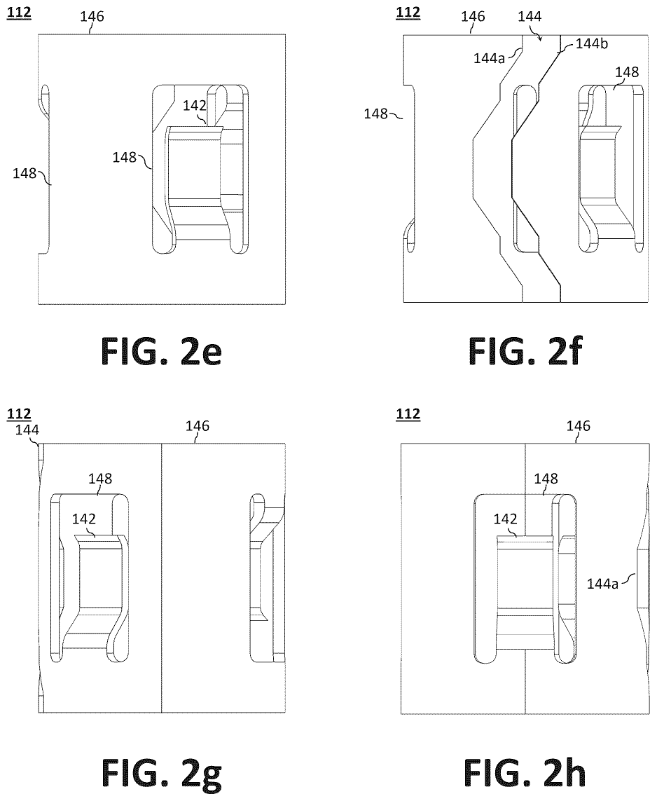

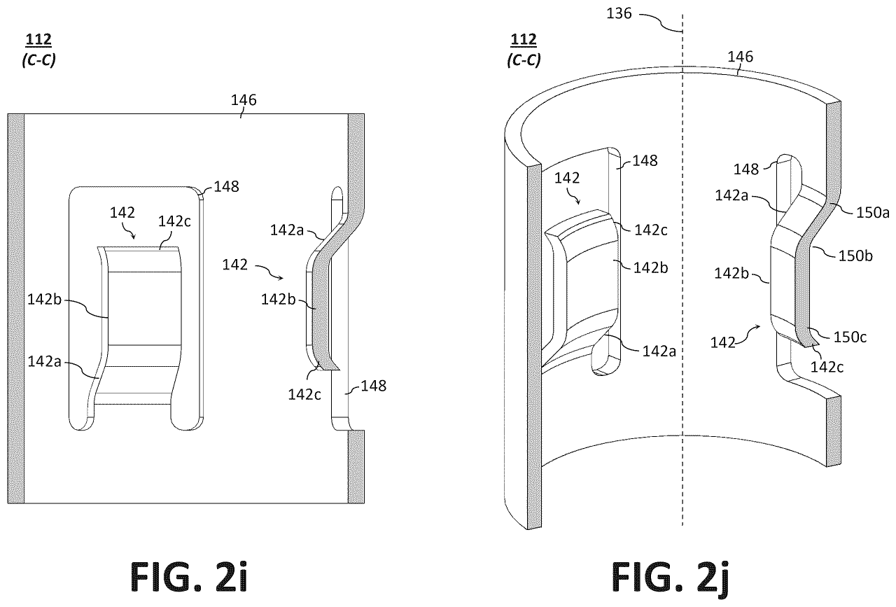

The spring clip 112 is configured to be retained within an interior sleeve through-hole 116 formed by the threaded sleeve 114, while the fastener 108 resides within a passageway 118 of the spring clip 112. The fastener 108 can be pre-captured into the compensating assembly 110 through friction via the spring clip 112 when positioned in the sleeve through-hole 116 of the threaded sleeve 114. In practice, the fastener assembly 102 can be provided as a pre-assembly that is then installed into the first component 104 for pre-capturing. The spring clip 112 will be further described in connection with FIGS. 2a through 2l.

To facilitate attachment via the fastener assembly 102, both the first component 104 and the second component 106 can include one or more engagement features. For example, the first component 104 and the second component 106 each comprise an opening 124 formed therein. The opening 124 can be formed in the first component 104 and/or the second component 106 during manufacturing or added post-manufacture through a mechanical process (e.g., drilling, cutting, carving, etc.). The opening 124 formed in the first component 104 extends between and through opposite surfaces 104a and 104b (such as a top surface and a bottom surface) of the first component 104. In some examples, the opening 124 can be threaded. For example, the opening 124 in the second component 106 can be threaded and configured to engage the fastener 108.

The fastener 108 is configured to pass through the openings 124 and the compensating assembly 110 to mechanically engage and couple with the second component 106 and/or a nut 126. The male fastener 108 can be rotated relative to the nut 126 about its axis of rotation (e.g., the central longitudinal axis 136) to join and compress the first component 104 and the second component 106 relative to one another. The threaded sleeve 114 is positioned over the opening 124 of the first component 104. The shank 108b extends through the passageway 118 and the opening(s) 124. The fastener-retaining system 100 securely connects the fastener 108 to the first component 104. When assembled, the compensating assembly 110 is compressively trapped between the upper surface 104a of the first component 104 and a portion of the fastener 108, such as the lower surface of the collar 108c. The height of the compensating assembly 110 can be adjusted by rotating the threaded sleeve 114 relative to the retainer 120 to adjust the distance between the first component 104 and the second component 106.

Certain components of the fastener assembly 102 may be fabricated from metal tubes and/or metal sheets via metal-drawing, metal-stamping, or other metal-forming techniques. For example, the spring clip 112 and the retainer 120 can be formed through a metal-stamping process. Other components of the compensating assembly 110 may be fabricated from plastic materials using plastic injection molding, additive manufacturing, or similar techniques. It is also contemplated that components of the fastener assembly 102 could be fabricated using material extrusion (e.g., fused deposition modeling (FDM), stereolithography (SLA), selective laser sintering (SLS), material jetting, binder jetting, powder bed fusion, directed energy deposition, VAT photopolymerization, or other suitable additive manufacturing/3D printing processes).

The first component 104 and the second component 106 may be, for example, automotive panels or other automotive components. Depending on the application, one or both components may be fabricated from metal (or a metal alloy), synthetic or semi-synthetic polymers (e.g., acrylonitrile butadiene styrene (ABS), polyvinyl chloride (PVC)), composite materials (e.g., fiberglass), or a combination thereof. In the automotive industry, example first components 104 include, without limitation, door trim panels, moldings, trim pieces, and other substrates (used as either interior or exterior surfaces). The second component 106 may be a frame, an automotive panel, or a structural vehicle component such as doors, pillars (e.g., A-pillar, B-pillar, C-pillar), dashboard components (e.g., cross members, brackets, frames), seat frames, center consoles, fenders, or sheet-metal frameworks.

After the first component 104 and the second component 106 are assembled, as illustrated in FIG. 1e, the second component 106 can be partially or fully covered by the first component 104. In some examples, one or both components can include additional attachment features. The fastener assembly 102 may also comprise a seal to mitigate dust, dirt, and/or moisture penetration through the openings 124. The seal may be embodied as a ring (e.g., an annulus) fabricated from foam, thermoplastic, rubber, or similar materials. For example, a seal can be configured to surround a portion of the male fastener 108 (e.g., the shank 108b) and positioned between the head 108a and the second component 106 and/or between the flange 130 and the second component 106.

While FIG. 1g illustrates the fastener-retaining system 100 as being coupled to the second component 106 via a nut 126, other fastening techniques and arrangements are contemplated. For example, instead of a threaded nut 126, a friction-based fastener could be used (e.g., a clip, sleeve, etc.).

FIGS. 2a and 2b illustrate, respectively, first and second isometric views of the spring clip 112 in accordance with an aspect of this disclosure. FIGS. 2c and 2d illustrate, respectively, top and bottom plan views of the spring clip 112, while FIGS. 2e through 2h illustrate, respectively, first, second, third, and fourth side elevation views of the spring clip 112. FIGS. 2i and 2j illustrate, respectively, side and isometric views of the spring clip 112 taken along cutline C-C (FIG. 2d), while FIGS. 2k and 2l illustrate, respectively, side and isometric views of the spring clip 112 taken along cutline D-D (FIG. 2d).

As illustrated, the spring clip 112 generally comprises a cylindrical sidewall 146 that is coaxial with the central longitudinal axis 136. The spring clip 112 defines various engagement features formed in or on the cylindrical sidewall 146. For example, the illustrated spring clip 112 includes a plurality of spring tabs 142, each positioned within and coupled to a window 148 of the cylindrical sidewall 146. During the stamping process, the metal plate can be stamped to form the window 148 and the outer profile or shape of the spring tabs 142. Each spring tab 142 is therefore resiliently coupled at an edge of a window 148 in a cantilevered fashion and is bent inwardly toward the central longitudinal axis 136.

As best illustrated in FIGS. 2c and 2d, the cylindrical sidewall 146 may include three windows 148 (and corresponding spring tabs 142) that are evenly distributed about the central longitudinal axis 136. More specifically, each of the three windows 148 is formed in the cylindrical sidewall 146 at 120-degree intervals about the central longitudinal axis 136. The cylindrical sidewall 146 further comprises a slot 144 that allows the cylindrical sidewall 146 to flex (e.g., move toward or away from the central longitudinal axis 136) during installation.

While three windows 148 are illustrated, additional or fewer windows 148 may be employed depending on size and/or the number of connection points. For example, two windows 148 can be evenly distributed about the central longitudinal axis 136 (i.e., 180 degrees apart), four windows 148 can be evenly distributed (i.e., 90 degrees apart), and so on. Similarly, while the windows 148 are illustrated as evenly distributed, they can instead be distributed at different intervals. In some cases, it may be advantageous to concentrate the windows 148 (and spring tabs 142) in a particular region.

Each spring tab 142 is bent at one or more locations along its length (illustrated as a first bend 150a, a second bend 150b, and a third bend 150c) to define a desired profile shape, an example of which is shown in FIGS. 2i and 2k. The spring clip 112 can be fabricated from a flat, rectangular metal plate using a metal-stamping process. After stamping the metal plate to define its outer perimeter and one or more features (e.g., the windows 148 and spring tabs 142), the metal plate is bent about its central longitudinal axis 136 to form the cylindrical sidewall 146.

The spring clip 112 includes resiliently cantilevered spring tabs 142 formed within windows 148 on the cylindrical sidewall 146. The spring clip 112 can therefore incorporate multiple spring tabs 142 positioned within windows 148 on the cylindrical sidewall 146. The spring tabs 142 are configured to secure engagement, with a geometry that enhances their functionality and reduces interference with other components, such as the fastener 108. The spring tabs 142 are formed during the metal-stamping process and are resiliently coupled to an edge of each window 148 in a cantilevered fashion.

Each spring tab 142 is bent inward toward or away from the central longitudinal axis 136 at multiple points along its length to achieve a functional profile. Specifically, the illustrated spring tab 142 includes three bends: the first bend 150a directs the tab inward, the second bend 150b redirects it outward to form an angled root section 142a, and the third bend 150c further redirects the tab outward, creating a body section 142b and a free end 142c.

The design of the spring tabs 142 improves flexibility and durability while enhancing engagement with associated components. The outwardly angled free end 142c reduces insertion forces during assembly and protects against damage. The cantilevered design of the spring tabs 142 ensures greater movement during assembly, mitigating the risk of interference between the tab and the fastener. Conversely, if the spring tab 142 were rigidly attached at both ends, interference could occur, potentially resulting in damage to the threads or other assembly elements. Additionally, the cantilevered structure allows for greater deflection, ensuring smooth operation and reducing the likelihood of wear or damage over time.

The angled root section 142a is oriented transversely to the cylindrical sidewall 146 and the central longitudinal axis 136, providing a secure attachment point with enhanced flexibility. The body section 142b runs generally parallel to the cylindrical sidewall 146, while the free end 142c angles outwardly from the central longitudinal axis 136. This outward angle serves as a lead-in, reducing insertion forces and minimizing the risk of sharp-edge interference with other assembly components, such as the fastener 108. Furthermore, the free end 142c of the spring tabs 142 allows for increased movement during assembly and mitigates interference between the free end 142c and the fastener 108. Conversely, if the spring tab 142 were attached at both ends, the fastener 108 could interfere with the spring tab 142, potentially causing damage (e.g., to the threads).

The slot 144 is formed by the separation between the first edge 144a and the second edge 144b of the metal plate. The short edges (i.e., the first edge 144a and the second edge 144b) of the metal plate may be spaced apart from one another once bent to assume the cylindrical sidewall 146, thereby defining the slot 144 (e.g., a gap or spacing) between them in a direction generally along the central longitudinal axis 136. The spring clip 112 therefore includes a slot 144 defined by spaced-apart first and second edges 144a and 144b of the cylindrical sidewall 146.

The spaced-apart first and second edges 144a and 144b, once bent into the cylindrical configuration, define the slot 144 along the central longitudinal axis 136 to mitigate entanglement or sticking during storage or shipment. For example, the edges of the slot 144 are shaped with non-linear profiles which, as illustrated in FIGS. 2f and 2k, are configured as stepped, trapezoidal profiles.

The design of the spaced-apart first and second edges 144a and 144b obstructs any direct linear pathway or line-of-sight 152 through the slot 144, reducing the likelihood of clips becoming stuck together. That is, the illustrated first and second edges 144a and 144b are shaped to mitigate entanglement with other spring clips during shipment and/or storage, using non-linear profiles that disrupt direct pathways through the slot 144. For instance, with reference to FIGS. 2f and 2k, each of the first edge 144a and the second edge 144b can exhibit a stepped, trapezoidal profile. The first edge 144a and the second edge 144b are shaped such that there is no direct linear pathway (e.g., line-of-sight 152) through the slot 144 between them that is not at least partially obstructed by one of the edges. While FIG. 2f illustrates the first edge 144a and the second edge 144b as having a stepped, trapezoidal profile, other shapes are also contemplated.

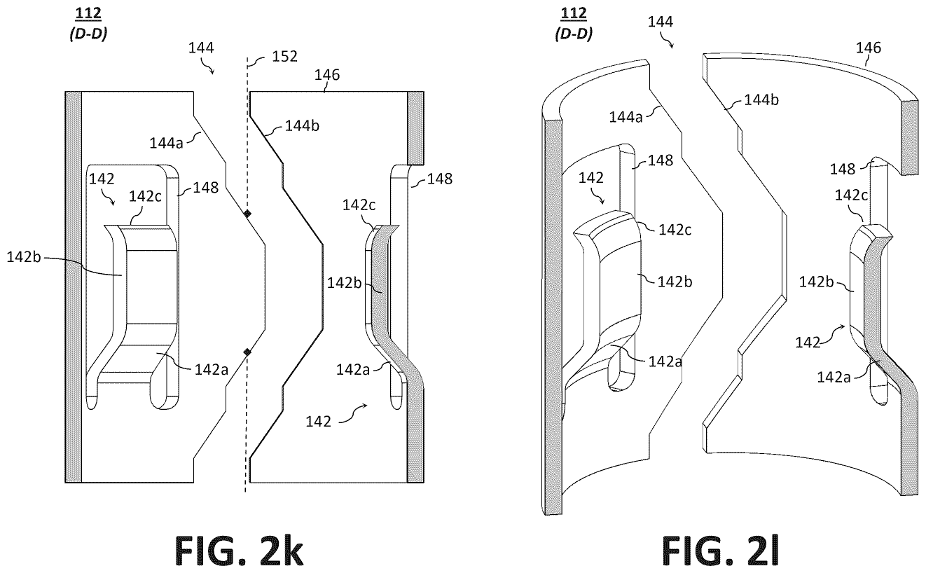

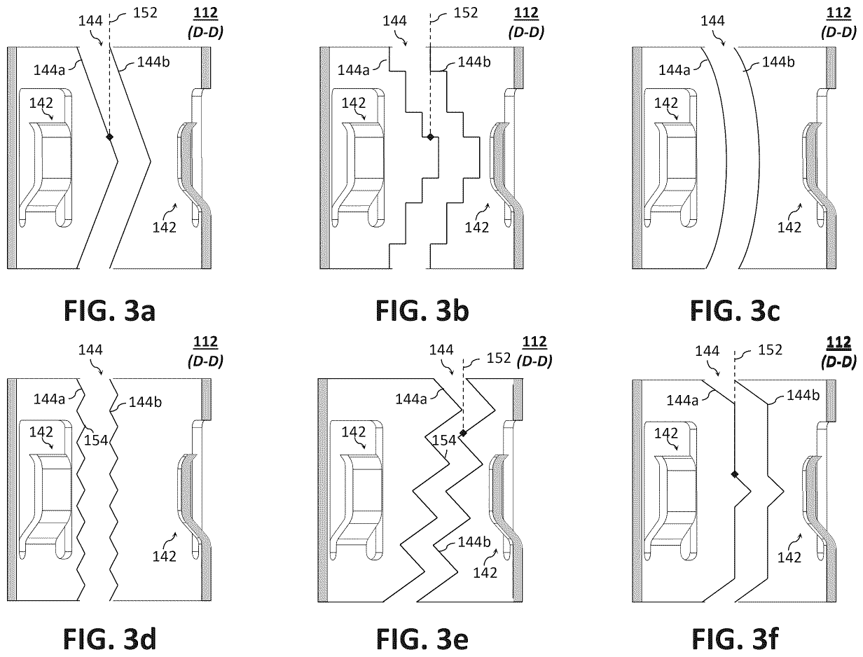

FIGS. 3a through 3f illustrate alternative slot 144 designs for use with a spring clip 112 in accordance with another aspect of this disclosure. FIG. 3a illustrates a spring clip 112 with a slot 144 where each of the first edge 144a and the second edge 144b has a triangular profile. FIG. 3b illustrates a spring clip 112 with a slot 144 where each of the first edge 144a and the second edge 144b has a stepped, quadrilateral profile.

FIG. 3c illustrates a spring clip 112 with a slot 144 where each of the first edge 144a and the second edge 144b has a curved profile (e.g., half-oval, half-circular, or half-elliptical). In this particular example, the line-of-sight 152 is not obstructed; however, the line-of-sight 152 could be obstructed by adjusting the distance between the first edge 144a and the second edge 144b or by increasing the degree of curvature such that the two curved portions become nested.

FIG. 3d illustrates a spring clip 112 with a slot 144 where each of the first edge 144a and the second edge 144b has a straight sawtooth profile. In this particular example, the line-of-sight 152 is not obstructed; however, the line-of-sight 152 could be obstructed by adjusting the distance between the first edge 144a and the second edge 144b or by modifying the height of each tooth 154. FIG. 3e illustrates a spring clip 112 with a slot 144 where each of the first edge 144a and the second edge 144b has an angled sawtooth profile composed of a plurality of teeth 154.

FIG. 3f illustrates a spring clip 112 with a slot 144 where each of the first edge 144a and the second edge 144b has an alternative geometric pattern. In this case, the profile is illustrated as a trapezoid with a triangular portion that obstructs the line-of-sight 152. The profiles shown in FIGS. 3a through 3f can be adjusted as desired to either obstruct or maintain the line-of-sight 152.

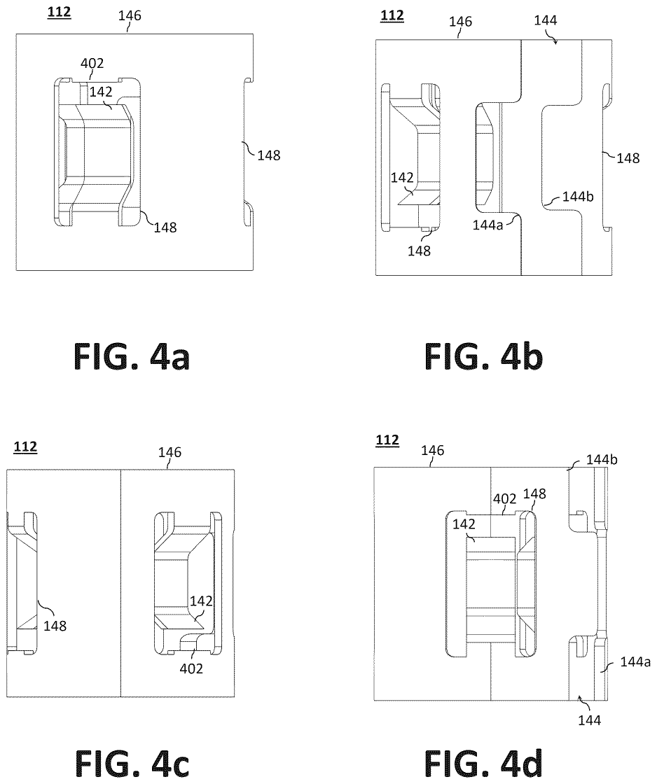

FIGS. 4a through 4d illustrate, respectively, first, second, third, and fourth side elevation views of a spring clip 112 in accordance with yet another aspect of this disclosure. The spring clip 112 of FIGS. 4a through 4d is generally similar to the spring clip 112 of FIGS. 2a through 2l and 3a through 3f; however, it incorporates several modifications to improve manufacturability and anti-tangling performance. For brevity, common elements and features are not reiterated. In this example, changes are made to the trim perimeter of the window 148 surrounding the three spring tabs 142, as well as to the geometry of the slot 144 that assists with anti-tangling. As illustrated, the slot 144 is shaped to define a generally quadrilateral notch (shown as rectangular) on the first edge 144a and a generally quadrilateral tab (shown as rectangular) on the second edge 144b, such that the notch and tab cooperate to reduce the likelihood of entanglement with adjacent spring clips. Additionally, the trim perimeter of the window 148 around the spring tabs 142 is revised to increase ease of manufacturing. In particular, the spring tabs 142 are stamped and bent such that a remnant of material 402 remains along the trim perimeter of the window 148 at the location where the free end of each spring tab 142 is cut from the surrounding trim perimeter of the window 148, thereby simplifying the stamping process while maintaining the desired functional geometry of the spring tabs.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A spring clip comprising:
a cylindrical sidewall defining a central longitudinal axis;
a slot in the cylindrical sidewall defined by spaced-apart first and second edges; and
a plurality of cantilevered spring tabs formed in the cylindrical sidewall,
wherein each of the plurality of cantilevered spring tabs extends inward toward the central longitudinal axis.

2. The spring clip of claim 1, wherein the spaced-apart first and second edges are configured to reduce entanglement by obstructing a direct line-of-sight through the slot.

3. The spring clip of claim 1, wherein each of the spaced-apart first and second edges has a non-linear profile.

4. The spring clip of claim 1, wherein each of the spaced-apart first and second edges has a stepped, trapezoidal profile.

5. The spring clip of claim 1, wherein each of the spaced-apart first and second edges has a triangular profile.

6. The spring clip of claim 1, wherein each of the spaced-apart first and second edges has a stepped, quadrilateral profile.

7. The spring clip of claim 1, wherein each of the spaced-apart first and second edges has a curved profile.

8. The spring clip of claim 1, wherein each of the spaced-apart first and second edges has a sawtooth profile.

9. The spring clip of claim 1, wherein each of the plurality of cantilevered spring tabs is positioned within a window formed in the cylindrical sidewall.

10. The spring clip of claim 9, wherein each of the plurality of cantilevered spring tabs includes a root section, a body section, and a free end.

11. The spring clip of claim 10, wherein the root section is coupled to an edge of the window.

12. The spring clip of claim 10, wherein the body section runs generally parallel to the cylindrical sidewall.

13. The spring clip of claim 10, wherein the root section is transverse relative to the central longitudinal axis.

14. The spring clip of claim 10, wherein the free end extends outwardly away from the central longitudinal axis.

15. The spring clip of claim 1, wherein the spring clip is a stamped-metal spring clip.

16. A spring clip comprising:
a cylindrical sidewall defining a central longitudinal axis;
a plurality of windows formed in the cylindrical sidewall and distributed evenly about the central longitudinal axis, wherein each of the plurality of windows includes a cantilevered spring tab that extends inward toward the central longitudinal axis; and
a slot in the cylindrical sidewall defined by spaced-apart first and second edges, wherein each of the spaced-apart first and second edges has a non-linear profile.

17. The spring clip of claim 16, wherein the cantilevered spring tab includes a root section that is coupled to an edge of the window, a body section, and a free end that extends outwardly away from the central longitudinal axis.

18. The spring clip of claim 17, wherein the body section runs generally parallel to the cylindrical sidewall.

19. The spring clip of claim 16, wherein the spring clip is a stamped-metal spring clip.

20. A fastener assembly for coupling a first component and a second component comprising:
a fastener;
a threaded sleeve having a threaded body defining a sleeve through-hole;
a retainer configured to couple with the first component, wherein the retainer includes an internally-threaded collar configured to threadedly receive the threaded sleeve;
a spring clip having a cylindrical sidewall with a passageway defining a central longitudinal axis, a slot in the cylindrical sidewall defined by spaced-apart first and second edges, and a plurality of cantilevered spring tabs formed in the cylindrical sidewall, wherein each of the plurality of cantilevered spring tabs extends inward toward the central longitudinal axis and is positioned within windows formed in the cylindrical sidewall,
wherein the sleeve through-hole is configured to receive the spring clip, and
wherein the passageway is configured to receive the fastener.
